(19) United States
(12) Patent Application Publication
(10) Pub. No.: US 2022/0117831 A1
(43) Pub. Date: Apr. 21, 2022

(54) STICK WITH WHEEL, METHOD OF CONTROLLING STICK WITH THE WHEEL, AND COMPUTER READABLE MEDIUM

(71) Applicant: TOYOTA JIDOSHA KABUSHIKI KAISHA, Toyota-shi Aichi-ken (JP)

(72) Inventors: Eisuke Aoki, Toyota-shi Aichi-ken (JP); Tadashi Odashima, Toyota-shi Aichi-ken (JP); Eiji Tsuchiya, Nagakute-shi Aichi-ken (JP); Yoshihiro Mizuno, Nagakute-shi Aichi-ken (JP); Ryo Koyama, Nagakute-shi Aichi-ken (JP); Hidekazu Nishigaki, Nagakute-shi Aichi-ken (JP)

(73) Assignee: TOYOTA JIDOSHA KABUSHIKI KAISHA, Toyota-shi Aichi-ken (JP)

(21) Appl. No.: 17/504,943

(22) Filed: Oct. 19, 2021

(30) Foreign Application Priority Data
Oct. 21, 2020 (JP) 2020-176639

(51) Int. Cl. A61H 3/04

(52) U.S. Cl. CPC A61H 3/04; A61H 2201/5069; A61H 2003/043

(57) ABSTRACT

A stick with a wheel that is capable of assisting walking by power of a wheel and that is capable of driving the wheel according to desire of a user regarding walking is provided. The stick with the wheel includes the wheel and a drive part configured to drive the wheel.

### CROSS REFERENCE TO RELATED APPLICATIONS

This application is based upon and claims the benefit of priority from Japanese patent application No. 2020-176639, filed on Oct. 21, 2020, the disclosure of which is incorporated herein in its entirety by reference.

### BACKGROUND

The present disclosure relates to a stick with a wheel, a method of controlling the stick with the wheel, and a program.

Japanese Unexamined Patent Application Publication No. 2007-244535 discloses a stick to be used for assistance or training for walking, the stick including a wheel part and a ferrule part, both of which contact the ground surface when the stick is in a supporting state.

### SUMMARY

However, in the stick disclosed in Japanese Unexamined Patent Application Publication No. 2007-244535, it is required to move the stick only by power of a user. Therefore, there has been a demand for a stick capable of assisting walking by power of a wheel, and in particular, a stick capable of driving the wheel according to user's desire regarding walking. It has also been demanded to provide a stick capable of driving a wheel according to user's desire regarding walking while maintaining the stick at a stable posture.

An object of the present disclosure is to provide a stick with a wheel, a method of controlling the same, and a program capable of assisting walking by power of a wheel and capable of driving the wheel according to user's desire regarding walking.

A stick with a wheel according to one aspect of the present disclosure in order to attain the above object includes: a grip part that a user grasps; a switch that is provided in the grip part and is turned on when the user presses the switch by grasping the grip part; a sensor configured to detect an inclination of the stick; a drive part configured to drive the wheel; and a controller configured to control the drive part based on the inclination detected by the sensor when the switch is turned on. In the stick with the wheel according to this aspect, the switch is turned on, which causes the driving of the wheel to be controlled based on the inclination of the stick. Accordingly, according to this aspect, it becomes possible to assist walking by power of the wheel and drive the wheel according to user's desire regarding walking while maintaining the stick at a stable posture.

Further, the sensor included in the stick may be provided in the grip part or in the vicinity thereof. Accordingly, a change in the inclination of the stick increases in accordance with a force of the user (or an amount of movement), the change in the inclination may be easily detected and fine control may be performed.

The drive part may drive the wheel by a transmission mechanism that lacks backdrivability. By employing the transmission mechanism that lacks backdrivability, even when the user wants to stop walking suddenly, the rotation of the wheel can be immediately stopped in accordance with the user's motion. The transmission mechanism may include a worm gear. Accordingly, it is possible to form a transmission mechanism that lacks backdrivability with a simple structure.

Further, the switch may be a switch that is turned off when the user stops grasping the grip part, and the controller may control the drive part so as to stop the driving of the wheel when the switch is turned off. In this way, by employing the stop control by the switch being turned off, it is possible to prevent the size of the stick from increasing compared to a case in which a brake is separately provided and to perform sudden stop control.

Further, the controller may control the drive part so as to maintain an inverted state of the stick. Accordingly, it is possible to let the user walk stably while maintaining the angle of the stick to be constant.

A method of controlling a stick with a wheel according to another aspect of the present disclosure includes: detecting, by a sensor, an inclination of the stick; and controlling, by a controller, a drive part based on the inclination detected by the sensor when a switch is turned on. The stick includes the switch that is provided in a grip part that a user grasps and is turned on when the user presses the switch by grasping the grip part, the sensor configured to detect the inclination of the stick, the drive part configured to drive the wheel, and the controller. In the method of controlling the stick with the wheel according to this aspect, the switch is turned on, which causes the driving of the wheel to be controlled based on the inclination of the stick. Accordingly, according to this aspect, it becomes possible to assist walking by power of the wheel and drive the wheel according to user's desire regarding walking while maintaining the stick at a stable posture.

A program according to another aspect of the present disclosure is a program for causing a computer included in a stick with a wheel to execute wheel driving processing, in which the stick includes a switch that is provided in a grip part that a user grasps and is turned on when the user presses the switch by grasping the grip part, a sensor configured to detect an inclination of the stick, and a drive part configured to drive the wheel. The wheel driving processing includes: inputting the inclination of the stick detected by the sensor; and controlling the drive part based on the inclination input from the sensor when the switch is turned on. In the program according to this aspect, the switch is turned on, which causes the driving of the wheel to be controlled based on the inclination of the stick. Accordingly, according to this aspect, it becomes possible to assist walking by power of the wheel and drive the wheel according to user's desire regarding walking while maintaining the stick at a stable posture.

A stick with a wheel according to another aspect of the present disclosure includes: a wheel; and a drive part configured to drive the wheel by a transmission mechanism that lacks backdrivability. Since the stick with the wheel according to this aspect employs the transmission mechanism that lacks backdrivability, even when the user wants to stop walking suddenly, the rotation of the wheel can be immediately stopped in accordance with the user's motion. Accordingly, according to this aspect, it becomes possible to assist walking by power of a wheel and drive the wheel according to user's desire regarding walking.

The transmission mechanism may include a worm gear. Accordingly, it is possible to form a transmission mechanism that lacks backdrivability with a simple structure.

A stick with a wheel according to another aspect of the present disclosure includes: a grip part that a user grasps; a sensor configured to detect an inclination of the stick; a drive part configured to drive the wheel; and a controller configured to control the drive part in such a way that the inclination detected by the sensor maintains angles within a predetermined range. With the stick with the wheel according to this aspect, the driving of the wheel is controlled in such a way that the inclination of the stick maintains the angles within the predetermined range based on the inclination of the stick. Accordingly, according to this aspect, it becomes possible to assist walking by power of the wheel and drive the wheel according to user's desire regarding walking while maintaining the stick at a stable posture.

Further, the stick may include a setting part configured to set the angles within the predetermined range. Accordingly, it becomes possible to drive the wheel while maintaining the stick at a stable posture in such a way that the angle of the stick falls within the predetermined range that has been set.

The setting part may set the angles within the predetermined range based on the inclination detected by the sensor for the first time after the user has grasped the grip part. Accordingly, it becomes possible to drive the wheel while maintaining the stick at a stable posture in such a way that the angle of the stick falls within the predetermined range set based on the user's initial posture.

Alternatively, the setting part may set the angles within the predetermined range based on the inclination detected by the sensor, the inclination being maintained within an allowable error range for a predetermined period of time continuously for the first time after the user has grasped the grip part. Accordingly, it is possible to prevent the above angles within the predetermined range from being set in the middle of holding the stick and standing up.

A method of controlling a stick with a wheel according to another aspect of the present disclosure includes: detecting, by a sensor, an inclination of the stick; and controlling, by a controller, a drive part in such a way that the inclination detected by the sensor maintains angles within a predetermined range. The stick includes: the sensor configured to detect the inclination of the stick; the drive part configured to drive the wheel; and the controller. In the method of controlling the stick with the wheel according to this aspect, the driving of the wheel is controlled in such a way that the inclination of the stick maintains angles within the predetermined range based on the inclination of the stick. Accordingly, according to this aspect, it becomes possible to assist walking by power of the wheel and drive the wheel according to user's desire regarding walking while maintaining the stick at a stable posture.

A program according to another aspect of the present disclosure is a program for causing a computer included in a stick with a wheel to execute wheel driving processing, in which the stick includes a sensor configured to detect an inclination of the stick; and a drive part configured to drive the wheel. The wheel driving processing includes: inputting the inclination of the stick detected by the sensor; and controlling the drive part in such a way that the inclination input from the sensor maintains angles within the predetermined range. In the program according to this aspect, the driving of the wheel is controlled in such a way that the inclination of the stick maintains the angles within the predetermined range based on the inclination of the stick. Accordingly, according to this aspect, it becomes possible to assist walking by power of the wheel and drive the wheel according to user's desire regarding walking while maintaining the stick at a stable posture.

According to the present disclosure, it is possible to provide a stick with a wheel, a method of controlling the same, and a program capable of assisting walking by power of a wheel and driving the wheel according to user's desire regarding walking.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic side view showing one configuration example of a stick with a wheel according to a first embodiment;

FIG. 2 is a block diagram showing one example of a control system of the stick with the wheel according to the first embodiment;

FIG. 3 is a schematic side view showing a state in which a user increases his/her walking speed with the stick with the wheel shown in FIG. 1;

FIG. 4 is a flowchart for describing a processing example in the stick with the wheel shown in FIG. 2;

FIG. 5 is a flowchart for describing a processing example in a stick with a wheel according to a third embodiment; and

FIG. 6 is a diagram showing one example of a hardware configuration of the stick with the wheel.

### DESCRIPTION OF EMBODIMENTS

Hereinafter, the present disclosure will be described based on embodiments of the present disclosure. However, the disclosure set forth in claims is not limited to the following embodiments. Moreover, it is not absolutely necessary to provide all the configurations to be described in the following embodiments for solving the problems. Hereinafter, with reference to the drawings, embodiments will be described.

### First Embodiment

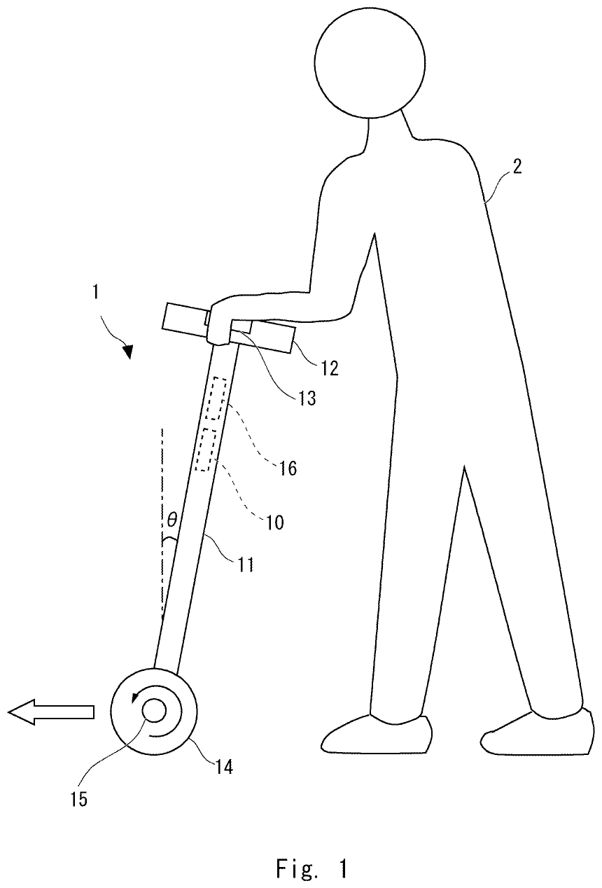

With reference to FIGS. 1 to 4, a first embodiment will be described. FIG. 1 is a schematic side view showing one configuration example of a stick with a wheel according to this embodiment.

As shown in FIG. 1, a stick 1 with a wheel according to this embodiment may include a controller 10, a body frame 11, a grip part 12, a switch 13, a wheel 14, a drive part 15, and a sensor 16.

While the body frame 11 may be, for example, a member having a cylindrical shape, the shape thereof is not limited thereto. The shape of the body frame 11 is not limited to a linear shape as shown in FIG. 1 and may instead be a bent shape. Further, the cross-sectional shape thereof is not limited to a circular shape. The grip part 12, which is a part that a user 2 can grasp, may be provided above the body frame 11. While the grip part 12 basically has such a form that the user 2 can grasp it with one hand, the user 2 can grasp the grip part 12 with both hands in some cases. The shape of the grip part 12 is not limited. In a case in which, for example, the body frame 11 has a bent shape, the grip part 12 may be integrally formed with the body frame 11 in an upper end side of the body frame 11.

The switch 13, which is a switch provided in the grip part 12, may either be a mechanical switch or an electronic switch such as a pressure sensor. The switch 13 may be provided in such a position that it can be pressed (or touched) by the user 2 when the user 2 grasps the grip part 12. As a matter of course, while the gripping method when the user 2 actually uses the stick 1 may be different for each user 2, the switch 13 may be provided in such a position that it can be pressed or touched by at least a general user. The applications of the switch 13 will be described later.

The drive part 15, which is a part that drives the wheel 14, may include, for example, a motor although the mechanism or the like thereof is not limited. Hereinafter, a description will be given of the drive part 15 which includes a motor as a main component thereof. The drive part 15 may be provided, for example, below the body frame 11, and a part indicated by the number 15 indicates the drive shaft part thereof.

The wheel 14, which is a wheel that can be rotated along the ground, can be attached to the drive shaft of the drive part 15. That is, the wheel 14 may be a driving wheel driven by the drive part 15. The wheel 14 may include a tire made of rubber, a soft iron or the like in a part of the wheel 14 that contacts the ground. Although it is sufficient that one wheel 14 be provided in the stick 1, a plurality of wheels 14 may instead be provided in the stick 1 (e.g., two wheels 14 may be provided so as to sandwich the body frame 11 in FIG. 1). By providing two or more of the wheels 14, the user is able to perform stable walking. When, for example, two wheels 14 are provided on the right and left sides of the stick 1, a control to change the moving direction may be performed by adjusting the torque amount of the right wheel and the torque amount of the left wheel.

The sensor 16, which is a sensor that detects the inclination of the stick 1, may be provided, for example, inside the body frame 11. While the sensor 16 may be, for example, an acceleration sensor, an optical sensor or the like, this is merely one example. As described above, the switch 13 is disposed in the grip part 12 and is turned on by the user 2 who grasps the stick 1 pressing this switch 13. Further, the switch 13 may have a noticeable shape so that the user 2 is able to recognize it or the color of the switch 13 may be different from the other parts of the stick. Alternatively, a power supply switch for functioning a control system may be provided separately from the switch 13.

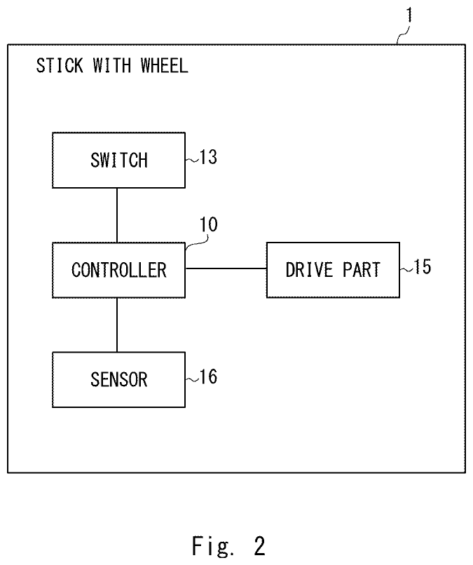

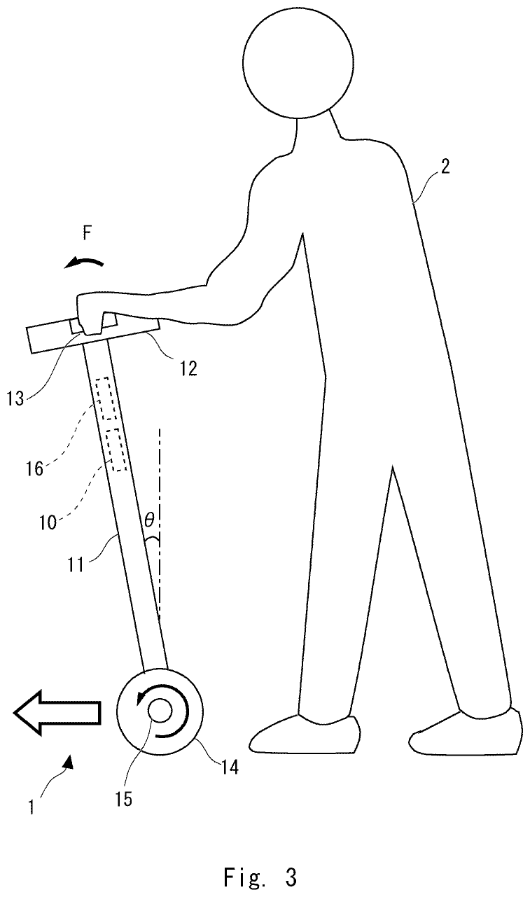

With reference also to FIGS. 2 and 3, control in the controller 10 will be described. FIG. 2 is a block diagram showing one example of a control system of the stick 1 according to this embodiment. FIG. 3 is a schematic side view showing a state in which the user 2 increases his/her walking speed with the stick 1 shown in FIG. 1.

As shown in FIG. 2, the controller 10 may be connected to the switch 13, the drive part 15, and the sensor 16 and can be formed so as to control the entire stick 1. The controller 10 is achieved by, for example, a processor such as a Central Processing Unit (CPU), a working memory, and a non-volatile storage device, or by an integrated circuit. This storage device may store a program for control executed by the processor and the processor may load this program to the working memory and execute this program, whereby the function of the controller 10 may be achieved.

When the switch 13 is turned on, the controller 10 controls the drive part 15 based on the inclination detected by the sensor 16. That is, when the switch 13 is turned on, the controller 10 controls the drive part 15 based on the inclination detected by the sensor 16, thereby controlling the driving of the wheel 14.

When, for example, the user 2 has moved the stick 1 while applying a force F in such a way that the inclination θ detected by the sensor 16 is changed from a position close to the user 2 as shown in FIG. 1 to a position that is away from the user 2 as shown in FIG. 3, the controller 10 performs the following control. In this case, the controller 10 controls the drive part 15 so as to increase the rotation speed of the wheel 14. While the angle θ is defined as an angle in the front-back direction with respect to the vertical direction in this description, this is merely one example. As a matter of course, an azimuth angle may be taken into account. The same is applicable to the definitions of the other angles described below.

In contrast, when the inclination θ is changed from the state as shown in FIG. 3 to the state as shown in FIG. 1, the controller 10 controls the drive part 15 so as to decrease the rotation speed of the wheel 14. Whether to increase or decrease the rotation speed may be determined, for example, depending on the magnitude and the direction of the force F. Further, the change in the rotation speed of the wheel 14 may be caused, for example, by a change in the angular velocity or the angular acceleration of the rotation of the wheel 14, and how it should be changed varies depending on the control system to be implemented.

Further, the controller 10 is able to control the rotation of the wheel 14 with the movement speed relative to the actual ground as a target based on the inclination θ. For example, the controller 10 may perform control in such a way that the user can move at a constant speed on the ground when the user simply inclines the stick forward as shown in FIG. 3 and perform control so as to stop the movement when the inclination of the stick is changed backward with respect to this inclination.

While the forward moving direction is shown by the white arrows and the rotation direction of the wheel 14 at the time of the forward movement is shown by the arrows in FIGS. 1 and 3, the controller 10, the wheel 14, and the drive part 15 may be configured in such a way that backward movement may be performed as well. When the backward movement is performed, a control method in which control by the inclination θ is stopped may be employed.

Further, the controller 10 is also able to control the drive part 15 so as to maintain the inverted state of the stick 1 based on θ detected by the sensor 16 (that is, perform inverted pendulum control). Accordingly, the user is able to walk stably while the angle of the body frame 11 of the stick 1 is controlled to be kept constant. This inverted pendulum control is also one example for controlling the drive part 15 based on the inclination θ and may be combined with another control. Further, the inverted state may be a state in which the body frame 11 is directed in the vertical direction or may instead be based on an angle inclined forward or backward by a predetermined angle.

In particular, the sensor 16 may be provided in the vicinity of the grip part 12 as illustrated in FIG. 1 or in the grip part 12. By providing the sensor 16 in such a way that it is provided near the hand of the user, the change in the inclination θ becomes large depending on the force F of the user 2 (or the amount of movement), as a result of which the change in the inclination θ may be easily detected and fine control may be performed. Further, accordingly, the acceleration of the moving direction is hard to be detected by the sensor 16 and there is no need to provide a gyro function in the sensor 16.

Hereinafter, a control method according to this embodiment (hereinafter referred to as this method) that may be executed in the stick 1 will be described. This method is a method of controlling the stick 1, more specifically, a method of controlling the drive part 15, and includes a detection step and a control step that will be described next. The detection step is a step in which the sensor 16 detects the inclination of the stick 1. The control step is a step in which the controller 10 controls the drive part 15 based on the inclination detected by the sensor 16 when the switch 13 is turned on.

While this control method may be achieved, for example, by using the above program for causing a computer provided as the controller 10 of the stick 1 to execute wheel driving processing described below, this is merely one example. The wheel driving processing includes a step of inputting the inclination of the stick 1 detected by the sensor 16 and a step of controlling the drive part 15 based on the inclination input from the sensor 16 when the switch 13 is turned on.

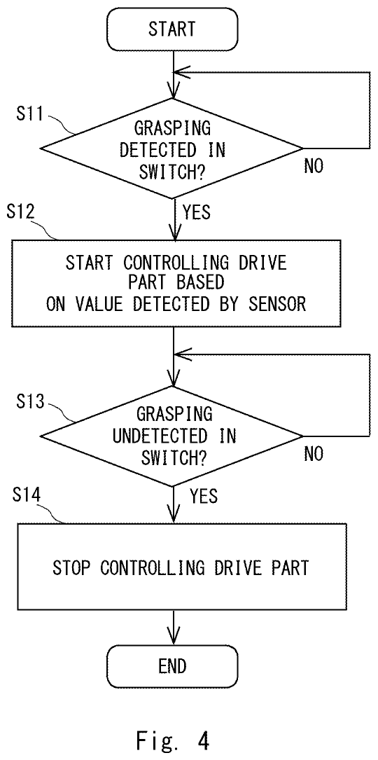

With reference to FIG. 4, examples of the above control method will be described. FIG. 4 is a flowchart of describing a processing example in the stick 1.

First, it is assumed that the controller 10 monitors the state of the switch 13 and the detection value (inclination θ), which is the output value from the sensor 16. The controller 10 determines whether or not the grasping operation by the user 2 has been detected in the switch 13 (Step S11), and when it has been detected, the processing moves to the following processing.

When it has been determined to be YES in Step S11 (when the grasping operation has been detected), the controller 10 starts controlling the drive part 15 based on the detection value detected by the sensor 16 (Step S12). Next, the controller 10 determines whether or not the grasping operation has become undetected in the switch 13 (Step S13). When the grasping operation has become undetected (when it has been determined to be YES), the control of the drive part 15 is stopped (Step S14). Accordingly, the driving of the wheel 14 is stopped when the user 2 no longer grasps the stick.

The above processing is repeated. That is, after Step S14 is ended, the processing starts again from Step S11.

As illustrated in Step S13 and the subsequent processing, the switch 13 may be a switch that is turned off when the user 2 stops the grasping operation. In this case, the controller 10 may control the drive part 15 so as to stop driving the wheel 14 when the switch 13 is turned off. That is, the switch 13 may serve as a switch for stopping the wheel 14 as an emergency when the user 2 releases his/her hand therefrom.

As described above, with the stick 1 with the wheel according to this embodiment, it is possible to assist walking with the power of the wheel 14 and to drive the wheel 14 according to desire of the user 2 regarding walking while maintaining the stick 1 at a stable posture.

The stick 1 starts/stops the driving by turning on/off the switch 13, whereby the stick 1 is able to move/stop the user 2 while reflecting desire of the user 2 regarding movement (according to user's desire). The stick 1 at least starts driving when the switch 13 is turned on, which enables the user 2 to move with the stick 1 when the user 2 wants to move. Further, the stick 1 can be used in a stable stick posture state by performing the drive control by the inclination θ. As described above, the stick 1 is able to drive, for example, the wheel 14 at a desired speed (walking speed) so that the user 2 can move in the direction that the user 2 wants to move and stop driving the wheel 14 so that the user 2 can stop when the user 2 wants to stop.

The effects of the stop control when the switch 13 is turned off will be additionally described.

In a stick that simply includes a wheel, a body frame, and a grip part, it may be possible to provide a brake in order to generate a braking force. However, in order to make the load applied to the brake large, the distance between the wheel and the brake needs to be increased, which causes an increase in the size of the stick. On the other hand, by employing the stop control performed when the switch 13 is turned off according to this embodiment, it is possible to prevent the size of the stick from increasing and to further perform sudden stop control. Further, when a motor is provided, it is possible to generate a braking force in the wheel by controlling the motor. However, it can be extremely dangerous if the motor control is disabled due to some error. On the other hand, by employing the stop control performed when the switch 13 is turned off like in this embodiment, it is possible to avoid such danger.

The effects of the drive control by the inclination θ will be additionally described.

When a user uses a stick that simply includes a wheel, a body frame, and a grip part, the user needs to apply a power to carry the stick in a part of the walking period (a period of an operation of putting the stick again on the ground). Further, when the user walks while using the stick, the operation of putting the stick again on the ground in accordance with the walking produces time during which the user does not put the stick on the ground, which causes a heavy burden on the knee during the movement and the user may easily lose his/her balance.

On the other hand, with the stick 1 according to this embodiment, it is possible to move the stick 1 as if the stick 1 is following the user's walking by assisting the user's force. That is, with the stick 1, there is no need for the walking person to adjust the moving speed of the stick 1, and the stick is moved in accordance with the walking. Further, the above operation may be performed in the stick 1 without performing particularly complicated sensing or complicated control. This is due to the following reason. That is, when the body of the user 2 moves with the user 2 having the stick 1 in his/her hand, the wrist corresponds to a hinge structure and the stick and the arm correspond to a link structure, and the inclination θ of the stick 1 is changed. Therefore, by performing control so as to correct the inclination θ, the user 2 can feel as if he/she is moving while automatically maintaining the distance from his/her body.

Further, it may be possible to generate a driving force in a stick that simply includes a wheel, a body frame, and a grip part by employing a passive wheel. When the passive wheel is employed, the user walks in a state in which the stick is inclined toward the user since the stick is moved by the user's force. When the user walks with the stick having this structure, a load is applied to the stick, which is likely to cause the stick to slide. In this case, the operation of the stick could be dangerous unless any countermeasure against this danger is taken on a method of generating a braking force. On the other hand, in the stick 1 according to this embodiment, the wheel 14 is configured to be driven by the drive part 15, that is, it is configured to include the driving wheel, which eliminates the need of taking the countermeasure against the above danger.

Further, when a stick is driven by a motor or the like in order to generate a driving force in a stick that simply includes a wheel, a body frame, and a grip part, it may be possible to control the movement of the stick (perform operation) by the user by adjusting the speed of the motor by an operation switch or the like while walking. This can be dangerous for the user if he/she is not accustomed to this operation. On the other hand, in the stick 1 according to this embodiment, the driving of the wheel 14 is controlled based on the inclination θ, which eliminates the need of taking into account the countermeasure against the above danger.

Further, when the motor requires a large driving force for a long time, the capacity of a battery to be mounted on the motor becomes large and the size of the battery increases as well. However, with the stick 1 according to this embodiment, even when the motor is used as the drive part 15, although the speed is controlled by this motor, the driving of the motor can be minimized since the control is limited to the drive control based on the inclination θ. Accordingly, according to this embodiment, a power source such as a battery can be minimized.

Further, in this embodiment, the drive part 15 may drive the wheel 14 by a transmission mechanism that lacks backdrivability. The transmission mechanism that lacks backdrivability may be, for example, a mechanism that includes a worm drive (worm gear). By using the worm gear, for example, a structure in which the driving can be performed from the motor but reverse drive from the side of the tire cannot be performed may be employed. However, the above-mentioned transmission mechanism is not limited to the worm gear and a known technology may be used. The worm gear makes it is possible to eliminate backdrivability with a simple structure. As a matter of course, the expression “lacks backdrivability” indicates that it can be regarded that the transmission mechanism substantially lacks backdrivability.

By employing the transmission mechanism that lacks backdrivability as described above, even when the user 2 suddenly wants to stop walking, the rotation of the wheel 14 can be immediately stopped in accordance the motion by the user 2. That is, by employing the transmission mechanism that lacks backdrivability, the tires can be automatically locked except when the user 2 is walking (or when a large external force is applied while the user 2 is walking), and thus it is possible to prevent danger such as overturn by the user 2. In particular, this transmission mechanism brings about larger effects when the example in which the switch 13 is configured so as to be turned off when the user 2 stops gripping the grip part is employed besides the transmission mechanism.

Further, in this embodiment, when a load is applied in the state in which the stick 1 is inclined toward the user, the motor receives a power on the regenerative side. However, since the stick can be locked by employing the aforementioned transmission mechanism such as a worm gear, the stick does not move in a state in which the motor is not driven. When the motor is driven from this state, the lock can be released, which enables the stick 1 to move forward only by the driving force. Therefore, by employing the above transmission mechanism in this embodiment, it is possible to reduce the consumption of the energy when the stick is stopped and to make the consumption of the energy when the stick is stopped zero by performing better control.

As a matter of course, certain effects can be obtained to some extent by just including a transmission mechanism having low backdrivability as the drive part 15.

### Second Embodiment

While a second embodiment will be described focusing mainly on the differences from the first embodiment, various application examples described in the first embodiment may be applied to the basic structure of the stick 1 etc.

A stick 1 according to this embodiment may have a structure similar to that described with reference to FIG. 1. It is sufficient that the stick 1 according to this embodiment include a drive part 15 that drives a wheel 14 by a transmission mechanism that lacks backdrivability and one or both of the switch 13 and the sensor 16 may not be, for example, provided. As described above, the drive part 15 may include, for example, a worm gear or the like as the transmission mechanism.

The stick 1 according to this embodiment includes, for example, a controller 10, which controls the drive part 15, thereby controlling the driving of the wheel 14. In this embodiment, by providing the switch 13, the controller 10 can continue the driving while the switch 13 is being pressed or touched, for example. Further, by providing the sensor 16 in this embodiment, the controller 10 is able to control the angular velocity or the angular acceleration of the rotation of the wheel 14 based on the inclination θ detected by the sensor 16.

As described in the first embodiment, by employing the transmission mechanism that lacks backdrivability according to this embodiment, even when the user 2 suddenly wants to stop walking, the rotation of the wheel 14 can be immediately stopped in accordance with the user's motion. The other effects are the same as those described in the first embodiment. Further, certain effects can be obtained to some extent by just including a transmission mechanism having low backdrivability as the drive part 15.

As described above, by providing the stick 1 with the wheel according to this embodiment, it becomes possible to assist walking by power of a wheel and drive the wheel according to desire of the user 2 regarding walking.

### Third Embodiment

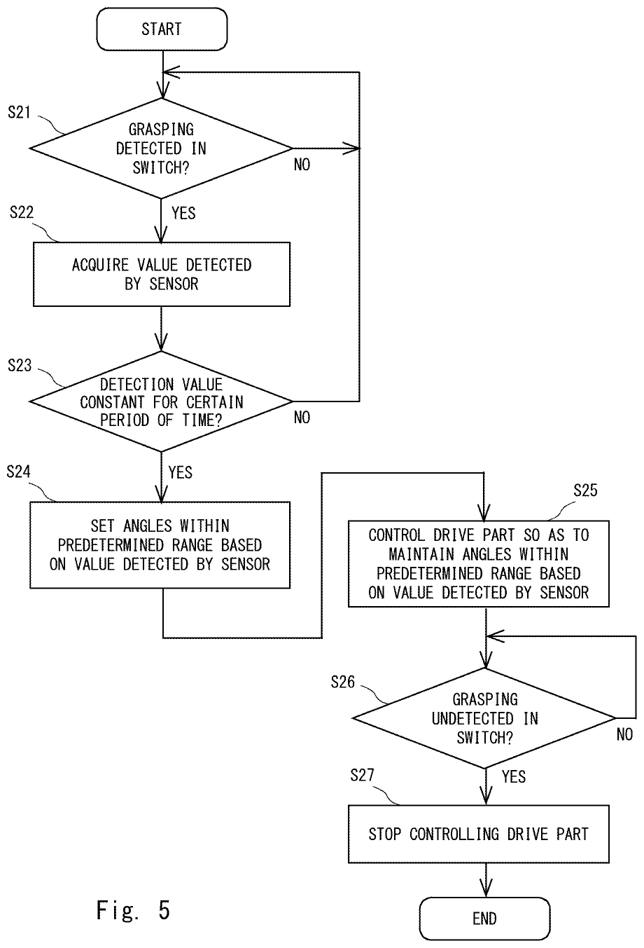

With reference also to FIG. 5, a third embodiment will be described. While this embodiment will be described focusing mainly on the differences from the first embodiment, various application examples described in the first and second embodiments may be applied to the basic structure of the stick 1, etc.

A stick 1 according to this embodiment may have a structure as described in FIG. 1. However, in the stick 1 according to this embodiment, the control performed by the controller 10 is different from that in the first embodiment. Further, the switch 13 may not be necessarily provided. As a control system, it is sufficient that the stick 1 include a controller 10, a drive part 15, and a sensor 16.

The controller 10 according to this embodiment controls the drive part 15 in such a way that the inclination θ detected by the sensor 16 maintains angles within a predetermined range (θ1-θ2). This control has been described as inverted pendulum control in the first embodiment, and θ1=−θ2 (the intermediate angle between θ1 and θ2 is set to be 0°) may be satisfied when the control is based on the vertical direction (the controller 10 performs control in such a way that the body frame 11 is directed in the vertical direction).

Further, since each user has a different symptom in his/her leg, these values may be configured in such a way that they can be set in the internal memory. That is, the stick 1 according to this embodiment may include a setting part configured to set the above angles within the predetermined range. This setting part may be included in the controller 10. This setting part may be configured in such a way that an operation part that accepts an operation from the user 2 is provided in the stick 1, the operation information is input to the controller 10, and this information is stored in the internal memory so that the controller 10 can read out this information at the time of control.

The setting part is not limited to have a configuration of setting the angles within the predetermined range by the input from the operation part. The setting part may set the angles within the predetermined range based on the inclination θ detected for the first time in the sensor 16 after the user 2 has grasped the grip part 12.

In particular, the setting part may set the angles within the predetermined range based on the inclination θ detected by the sensor 16, the inclination θ being the one (continuously detected inclinations) continuously maintained within the allowable error range (δ1-δ2) for the first time after the user 2 grasps the grip part 12. Further, since each user has a different symptom in his/her leg, the values δ1 and δ2 may be configured in such a way that they can be set in the internal memory. As described above, by determining the above angles within the predetermined range based on the angle when the switch 13 is turned on for the first time after the user 2 grasps the grip part and the continuously detected angles, it is possible to prevent the above predetermined range from being set at an angle in the middle of grasping the grip part 12 of the stick 1 and standing up.

The method of controlling the stick 1 according to this embodiment includes the above detection step and a control step as follows. The above detection step is a step of detecting, by the sensor 16, the inclination θ of the stick 1. In the above control step, the controller 10 controls the drive part 15 in such a way that the inclination θ detected by the sensor 16 maintains angles between θ1 and θ2.

While the above control method may be achieved, for example, by using the aforementioned program for causing a computer included as the controller 10 of the stick 1 to execute other wheel driving processing described below, this is merely an example. The other wheel driving processing includes a step of inputting the inclination of the stick 1 detected by the sensor 16 and a step of controlling the drive part 15 in such a way that the inclination input from the sensor 16 maintains the angles within the predetermined range.

With reference to FIG. 5, an example of the above control method will be described. FIG. 5 is a flowchart for describing a processing example in the stick 1 with the wheel according to this embodiment.

First, it is assumed that the controller 10 monitors the state of the switch 13 and a detection value (inclination θ), which is an output value from the sensor 16. The controller 10 determines whether or not the grasping operation by the user 2 has been detected in the switch 13 (Step S21). When the grasping operation has been detected, the processing proceeds to the following processing.

When it has been determined to be YES in Step S21 (when the grasping operation has been detected), the controller 10 acquires the detection value detected by the sensor 16 (Step S22) and determines whether or not the detection value is constant (within the allowable error range) for a certain period of time (the above predetermined period of time) (Step S23). When it has been determined to be NO in Step S23, the processing returns to Step S21. When it has been determined to be YES in Step S23, the controller 10 determines the above predetermined range based on the detection value θ detected by the sensor (or the median value, the average value or the like within the above predetermined period of time) and sets the range (Step S24).

After the above initial setting is performed, the controller 10 starts controlling the drive part 15 based on the detection value θ detected by the sensor 16 and controls the drive part 15 so as to maintain the above angles within the predetermined range (Step S25). Next, the controller 10 determines whether or not the grasping operation has become undetected in the switch 13 (Step S26). When it has been determined that the grasping operation has become undetected (YES in Step S26), the controller 10 stops controlling the drive part 15 (Step S27). Accordingly, the driving of the wheel 14 is stopped when the user 2 no longer grasps the grip part.

The above processing is repeated. That is, after Step S27, the processing starts again from Step S21.

As described above, with the stick 1 with the wheel according to this embodiment, it becomes possible to assist walking by the power of the wheel 14 and to drive the wheel 14 according to desire of the user 2 regarding walking while maintaining the stick 1 at a stable posture. In particular, in this embodiment, by setting the above angles within the predetermined range, the wheel 14 may be driven while maintaining the stick 1 at a stable posture in accordance with the operation setting by the user 2 or the initial posture.

### Alternative Examples

Next, alternative examples of the aforementioned first to third embodiments will be described.

The sticks 1 according to the aforementioned embodiments are not limited to the ones having the shapes, the structures, and the control examples illustrated in FIGS. 1-5, and may have other forms as long as they achieve functions of the respective parts. Further, the processes executed in the sticks 1 according to the embodiments (mainly the drive control of the drive part 15) may be combined as appropriate.

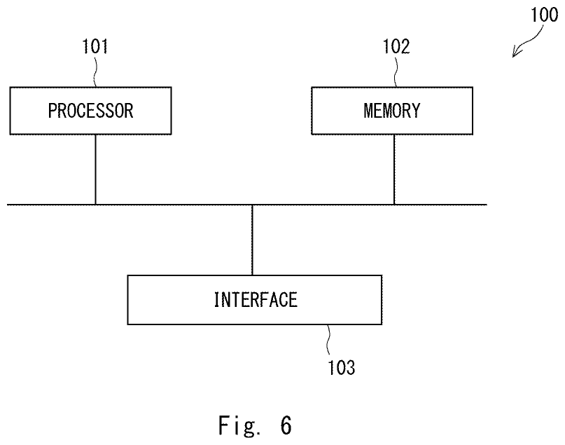

Further, the sticks 1 according to the first to third embodiments may each include, for example, the following hardware configuration. FIG. 6 is a diagram showing one example of a hardware configuration of a stick with a wheel.

A stick 100 with a wheel shown in FIG. 6 may include a processor 101, a memory 102, and an interface 103. For example, the interface 103 may include an interface with a drive part 15, an interface with a sensor 16, and an interface with a switch 13. Note that the configuration of the interface 103 varies depending on the embodiments.

The processor 101 may be, for example, a microprocessor, a Micro Processor Unit (MPU), a CPU or the like. The processor 101 may include a plurality of processors. The memory 102 is composed of, for example, a combination of a volatile memory and a non-volatile memory. The functions in the sticks 1 with the wheel described in the first to third embodiments are achieved by the processor 101 loading a program stored in the memory 102 and executing the loaded program while exchanging necessary information via the interface 103.

The above program may be the one described in the first embodiment and may be a program implemented in a similar way in the second and third embodiments as well. With regard to the first embodiment, for example, this program may be a program for causing a computer to execute the above-described detection step and control step. The other application examples have been described above and thus the descriptions thereof will be omitted.

The program includes instructions (or software codes) that, when loaded into a computer, cause the computer to perform one or more of the functions described in the embodiments. The program may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not limitation, transitory computer readable media or communication media can include electrical, optical, acoustical, or other form of propagated signals.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A stick with a wheel, comprising:
a grip part that a user grasps;
a switch that is provided in the grip part and is turned on when the user presses the switch by grasping the grip part;
a sensor configured to detect an inclination of the stick;
a drive part configured to drive the wheel; and
a controller configured to control the drive part based on the inclination detected by the sensor when the switch is turned on.

2. The stick with the wheel according to claim 1, wherein the sensor is provided in the grip part or in a vicinity thereof.

3. The stick with the wheel according to claim 1, wherein the drive part drives the wheel by a transmission mechanism that lacks backdrivability.

4. The stick with the wheel according to claim 1, wherein
the switch is a switch that is turned off when the user stops grasping the grip part, and
the controller controls the drive part so as to stop the driving of the wheel when the switch is turned off.

5. The stick with the wheel according to claim 1, wherein the controller controls the drive part so as to maintain an inverted state of the stick.

6. A stick with a wheel comprising:
a wheel; and
a drive part configured to drive the wheel by a transmission mechanism that lacks backdrivability.

7. The stick with the wheel according to claim 6, wherein the transmission mechanism includes a worm gear.

8. A stick with a wheel comprising:
a grip part that a user grasps;
a sensor configured to detect an inclination of the stick;
a drive part configured to drive the wheel; and
a controller configured to control the drive part in such a way that the inclination detected by the sensor maintains angles within a predetermined range.

9. The stick with the wheel according to claim 8, comprising a setting part configured to set the angles within the predetermined range.

10. The stick with the wheel according to claim 9, wherein the setting part sets the angles within the predetermined range based on the inclination detected by the sensor for a first time after the user has grasped the grip part.

11. The stick with the wheel according to claim 9, wherein the setting part sets the angles within the predetermined range based on the inclination detected by the sensor, the inclination being maintained within an allowable error range for a predetermined period of time continuously for a first time after the user has grasped the grip part.

12. A method of controlling a stick with a wheel, wherein
the stick includes a switch that is provided in a grip part that a user grasps and is turned on when the user presses the switch by grasping the grip part, a sensor configured to detect an inclination of the stick, a drive part configured to drive the wheel, and a controller, and
the method comprises:
detecting, by the sensor, the inclination of the stick; and
controlling, by the controller, the drive part based on the inclination detected by the sensor when the switch is turned on.

13. A method of controlling a stick with a wheel, wherein
the stick includes a sensor configured to detect an inclination of the stick, a drive part configured to drive the wheel, and a controller, and
the method comprising:
detecting, by the sensor, the inclination of the stick; and
controlling, by the controller, the drive part in such a way that the inclination detected by the sensor maintains angles within a predetermined range.

14. A non-transitory computer readable medium storing a program for causing a computer included in a stick with a wheel to execute wheel driving processing, wherein
the stick includes a switch that is provided in a grip part that a user grasps and is turned on when the user presses the switch by grasping the grip part, a sensor configured to detect an inclination of the stick, and a drive part configured to drive the wheel, and
the wheel driving processing comprises:
inputting the inclination of the stick detected by the sensor; and
controlling the drive part based on the inclination input from the sensor when the switch is turned on.

15. A non-transitory computer readable medium storing a program for causing a computer included in a stick with a wheel to execute wheel driving processing, wherein
the stick includes a sensor configured to detect an inclination of the stick and a drive part configured to drive the wheel, and
the wheel driving processing comprises:
inputting the inclination of the stick detected by the sensor; and
controlling the drive part in such a way that the inclination input from the sensor maintains angles within a predetermined range.
